(19) United States
(12) Patent Application Publication
(10) Pub. No.: US 2010/0065581 A1
(43) Pub. Date: Mar. 18, 2010

(54) BAG IN BOX CONTAINER SYSTEM

(75) Inventor: Scott R. Thomason, Macedonia, OH (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: MT Manufacturing, Inc., Solon, OH (US)

(21) Appl. No.: 12/412,880

(22) Filed: Mar. 27, 2009

Related U.S. Application Data
(60) Provisional application No. 61/191,887, filed on Sep. 13, 2008.

(51) Int. Cl. B65D 35/56; B31B 1/00

(52) U.S. Cl. 222/105; 493/393

(57) ABSTRACT

A bag-in-box container system includes a bag, a box, and a mechanism for fastening the bag and box combination. The bag may include a dispensing end with a collar and a groove. The box may have an opening through which a portion of the dispensing end protrudes when the bag is inside the box. A collar in the bag may resist the bag being pulled out of the box through the opening. The fastening mechanism may resist the portion of the dispensing end being pushed into the box through the opening.

### CROSS-REFERENCES TO RELATED APPLICATIONS

This application claims priority to U.S. Provisional Application No. 61/191,887 filed Sep. 13, 2008, the disclosure of which is hereby incorporated by reference in its entirety.

### FIELD OF THE INVENTION

The present application relates to container systems and, more particularly, to bag-in-box container systems for interaction with spraying or dispensing systems.

### BACKGROUND

Humans apply many products to their bodies for cosmetic purposes. These products include moisturizers, sunscreens, anti-aging treatments, UV tanning accelerators, sunless tanning products, and so on. Numerous forms of artificial tanning products are currently available, including lotions, creams, gels, oils, and sprays. These products are typically mixtures of a chemically-active skin colorant or a bronzer, in combination with moisturizers, preservatives, antimicrobials, thickeners, solvents, emulsifiers, fragrances, surfactants, stabilizers, sunscreens, pH adjusters, anti-caking agents, and additional ingredients to alter the color reaction.

Systems exist for applying artificial tanning products including spraying booths for fluid containment used in conjunction with handheld sprayers, and closed booths equipped with automated spraying systems. These spraying systems may use high pressure compressed air nozzles along with sunless tanning composition fluids supplied to the nozzle to create atomized sprays directed towards the body. Sunless tanning composition fluids, as well as fluids in countless other applications, must be packaged in containers suitable for transportation of the fluids, for interaction with spraying or dispensing systems, and for economically efficient disposal.

Conventionally, fluids have been packaged in rigid containers that provide satisfactory interaction with spraying or dispensing systems. However, these rigid containers are inefficient in terms of storage and disposal of empty containers because they retain their volume even after the fluids have been exhausted. Flexible containers such as bag-in-box containers provide more economically efficient containers in terms of storage and disposal. However, conventionally, these flexible containers have been used in applications that rely on pressurized air for evacuation of fluid from the bag while the bag-in-box system is sitting upright. Conventional, bag-in-box systems do not provide a sufficiently rigid container for proper interaction with spraying and dispensing systems that require upside-down installation for gravity to assist, at least in part, in the evacuation of the contents in the bag. Some of these upside-down applications may require also require a blind connection to be made between the bag-in-box system and dispensing machinery.

### SUMMARY

In one embodiment, a bag-in-box packaging or container system is provided. In the example embodiment, the flexible bag includes or has attached to it a dispensing end for dispensing a liquid from the bag. In the example embodiment, the dispensing end includes a collar and a groove, flange, or some variation of each. In the embodiment, the box has an opening for a portion of the dispensing end to protrude through the opening when the bag is inside the box. The opening in the box has a perimeter smaller than the perimeter of the collar retaining the bag inside the box when the material around the opening supports the collar and resists the bag from being pulled out of the box through the opening. In the example embodiment, the dispensing end is partially engaged within the box while a distal portion of the dispensing end protrudes through the opening and is retained outside of the box. By using the groove, or flange, the dispensing end is engaged and secured so that the dispensing end does not push inside the box.

In another embodiment, a bag-in-box packaging or container system is provided that includes a clip. In the example embodiment, the box includes an opening and the bag includes or has attached to it a dispensing end that partially protrudes through the opening in the box when the bag is disposed within the box. The dispensing end includes a collar and a groove, flange, or some variation of each. The collar disposed in the box prevents the bag from being pulled out of the box through the opening. The clip fastens the dispensing end to the box opposed to the collar by engaging the groove protruding through the opening, retaining a distal portion of the dispensing end outside of the box and resisting it from moving into the box.

### BRIEF DESCRIPTION OF DRAWINGS

The accompanying drawings, together with the detailed description provided below, describe exemplary embodiments of the claimed invention. In the drawings and description that follow, like elements are identified with the same reference numerals. The drawings are not to scale and the proportion of certain elements may be exaggerated for the purpose of illustration.

FIG. 1 illustrates a perspective front view of an embodiment of a bag-in-box container system.

FIG. 2 illustrates a perspective rear view of an embodiment of a bag-in-box container system.

FIG. 3 illustrates a perspective front exploded view of an embodiment of a bag-in-box container system.

FIG. 4 illustrates a perspective front exploded view of an embodiment of a bag-in-box container system with a clip.

FIG. 5 illustrates an exploded view of an embodiment of a bag-in-box container system.

FIG. 6 illustrates a perspective view of an embodiment of a bag-in-box container system

FIG. 7A illustrates a perspective front view of an embodiment of a bag-in-box container system.

FIG. 7B illustrates a perspective top view of an embodiment of a bag-in-box container system.

FIG. 8 illustrates a partially assembled example application for a bag-in-box container system.

FIG. 9 illustrates an expanded or close up view of the partially assembled example application for bag-in-box container systems of FIG. 8.

FIG. 10 illustrates a completely assembled example application for a bag-in-box container system.

FIG. 11 illustrates an expanded or close up view of the completely assembled example application for a bag-in-box container system of FIG. 10.

### DETAILED DESCRIPTION

The following includes definitions of selected terms. The definitions include various examples or forms of components that fall within the scope of a term. The examples are not intended to be limiting.

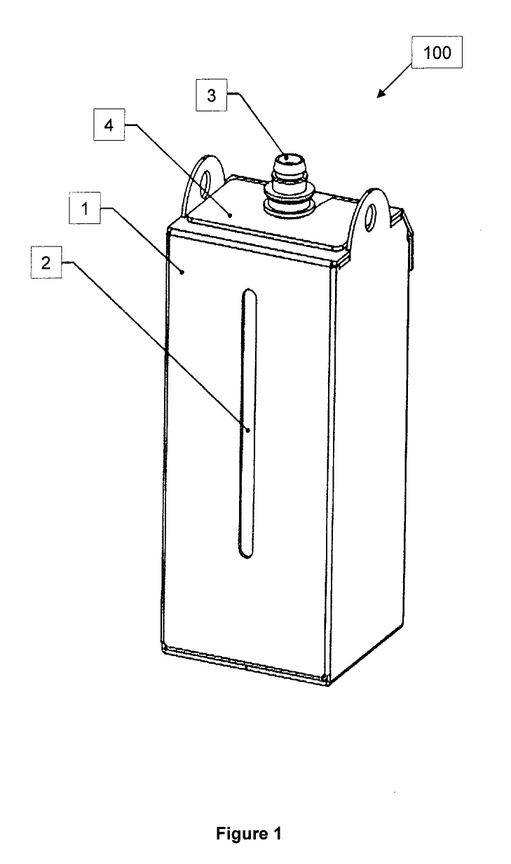

FIG. 1 illustrates a perspective front view of an embodiment of a bag-in-box container system. The example container system 100 includes a box 1. Box 1 may be constructed of various different materials (cardboard, plastic, and so on) to give box 1 suitable rigidity, weight, etc. for the specific application. Example container system 100 also includes a bag 2. Bag 2 may contain liquids such as those used for sunless tanning, as well as other liquids for various other uses. Bag 2 may have a valved fitting or dispensing end 3 that may provide a fluidic path for the fluid in bag 2. Example box 1 has an opening on one of its walls for the dispensing end 3 to partially come through. Dispensing end 3 may have annular ringed flanges or ribs for, among other functions, connecting system 100 to equipment or machinery using the fluids inside of bag 2. Dispensing end 3 may also include a collar (not shown) of a larger perimeter than the opening in box 1 such that the collar contacts the inside of box 1 around the opening. The contact between the collar and the inside of box 1 resists bag 2 from being pulled out of the box through the opening. Dispensing end 3 may also include a flange, rib, or set of flanges or ribs forming a groove or slot for a clip 4, a spring clip (not shown), or some other means of engagement to engage dispensing end 3 and resist a force pushing in a direction towards the inside of box 1.

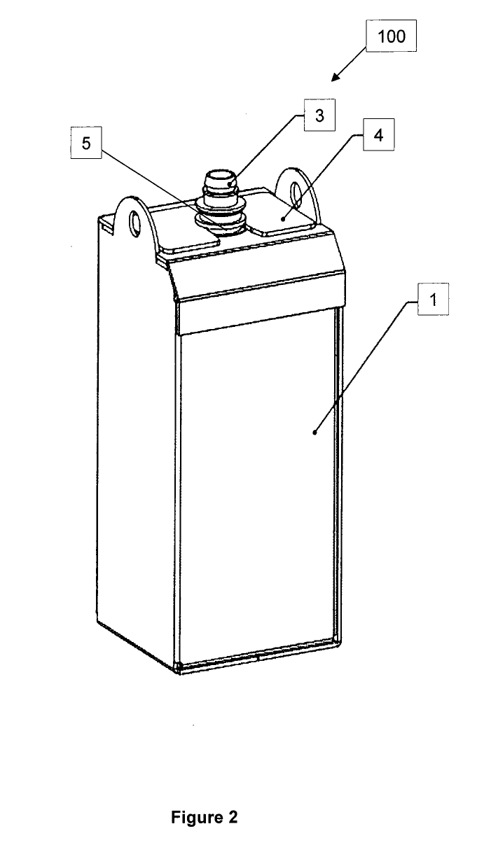

FIG. 2 illustrates a perspective rear view of an embodiment of a bag-in-box container system 100. In the example embodiment, dispensing end 3 includes a groove 5. The example embodiment also includes a clip 4 that engages groove 5 to hold dispensing end 3 in place relative to box 1. Engagement of groove 5 and clip 4 causes clip 4 to resist a force urging dispensing end 3 inside box 1 by, for example, force exerted on dispensing end 3 when connecting system 100 to dispensing or spraying machinery. During and after connection to the machinery, clip 4 distributes, at least partially, the force exerted on dispensing end 3 along the opening end outside wall of the box contributing to the rigidity of system 100.

Clip 4 may have an opening for sliding in place into groove 5 in dispensing end 3. Groove 5 may be formed by two spaced walls or flanges radially extending from dispensing end 3. Groove 5 may be located in dispensing end 3 so that the proximal most wall or flange of groove 5 is flush with the outside surface of the opening wall of box 1. In this example embodiment, groove 5 is disposed immediately outside of box 1 near the opening. Clip 4 may then engage dispensing end 3 at groove 5 with at least some surface area of clip 4 remaining in contact with the outside surface of the opening wall of box 1, providing for very little, if any, play of dispensing end 3 in and out of box 1.

Engaging a portion of dispensing end 3 outside box 1 may be accomplished by various other means. In an example prophetic embodiment, engagement of a groove 5 is accomplished by a flap integral to box 1 that slides into groove 5 and prevents dispensing end 3 from pushing into box 1 through the opening. In another prophetic embodiment, dispensing end 3 may be engaged by inserting a grooved insert into a flange in dispensing end 3. Dispensing end 3 may be alternatively or additionally engaged by a spring clip (not shown) that engages groove 5. Various other methods of engagement may be used.

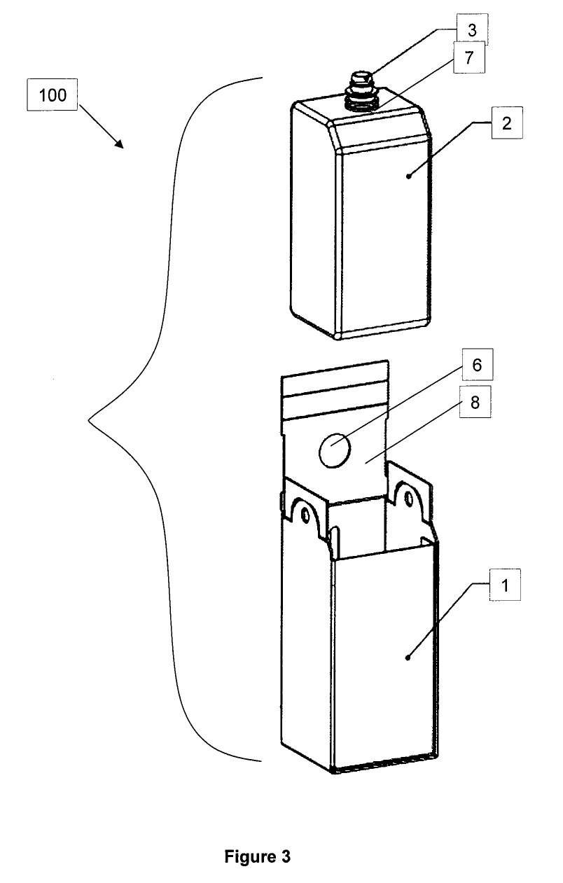

FIG. 3 illustrates a perspective front exploded view of an embodiment of a bag-in-box container system. In the example embodiment, bag-in-box container system 100 includes box 1 and bag 2. To assemble bag-in-box system 100, bag 2 is inserted inside box 1, and box 1 is closed with a portion of dispensing end 3 protruding through opening 6. Dispensing end 3 may also include a collar 7 of a larger perimeter than opening 6 such that collar 7 contacts the inside surface of top wall 8 around opening 6. The contact between collar 7 and the inside surface of top wall 8 resists bag 2 from being pulled out of the box through opening 6. Bag 2 may be manufactured of a flexible material. Box 1 may be designed and manufactured such that when fully assembled, bag-in-box system 100 with clip 4 engaged in groove 5 mimics a single, stable, rigid container.

In example system 100, opening 6 and collar 7 are shown to have circular geometries. In the example embodiment, the perimeters of opening 6 and collar 7 would be their respective circumferences. However, opening 6 and collar 7 may be of various non-circular geometries (square, oval, rectangular, and so on). In an alternate embodiment, collar 7 would be reinforced or supported by an additional clip (not shown) disposed inside box 1 and held in position with or without an additional groove on dispensing end 3.

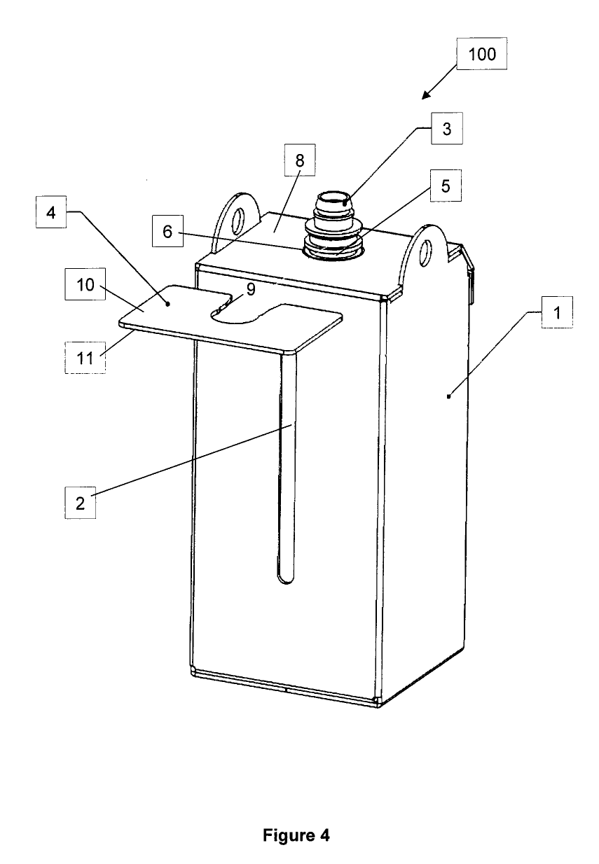

FIG. 4 illustrates a perspective front exploded view of an embodiment of a bag-in-box liquid container system 100 with a clip 4. In the example embodiment, after bag 2 has been inserted inside box 1 with dispensing end 3 protruding through opening 6, clip 4 may be inserted or slid into groove 5. Clip 4 has a shape complimentary to groove 5 such that clip 4 tightly fits on to groove 5 when pressed into engagement position. In this embodiment, clip 4 has a U-shaped opening. The U-shaped opening defines an engaging surface 9 for clip 4 to engage groove 5 of dispensing end 3 protruding through opening 6 in a wall of box 1. In a prophetic embodiment, engaging surface 9 may be part of a flap, integral to or separable from box 1, that slides into groove 5 to secure dispensing end 3 in place. In another prophetic embodiment, the engaging surface may be part of a spring clip or similar structure that engages groove 5 or some other portion of dispensing end 3 to secure dispensing end 3 in place. In other embodiments, engaging surface 9 could be formed by a discontinuous engaging surface or multiple engaging surfaces.

In one embodiment, clip 4 has top and bottom surfaces 10 and 11, respectively. In the example embodiment, when clip 4 is fully inserted into groove 5, top surface 10 contacts the distal wall of groove 5 preventing dispensing end 3 from recessing into box 1 through opening 6. The bottom surface 11, in turn, distributes at least some of the force applied to dispensing end 3 across the top wall 8 of box 1. This distribution of force along the larger area of top wall 8 makes bag-in-box system 100 relatively rigid. The rigidity of system 100 makes it suitable for connecting to dispensing equipment even when system 100 is inverted upside-down and connected to dispensing equipment in a blind connection where substantial force may be exerted on system 100 to permit dispensing end 3 to connect to a mating fitting fixed to dispensing machinery. System 100 may be sufficiently rigid to be self supporting in such an application when mounted by means of dispensing end 3 in an inverted angled or upside-down orientation.

In one embodiment, engaging surface 9 may have dimples for a snap engagement between clip 4 and groove 5. In another embodiment, engaging surface 9 may have a total engaging circumference in excess of half the outside circumference of groove 5 for a snap engagement. Clip 4, among other embodiments, could also be a spring clip (not shown) that may be compressed, placed over groove 5, and released to engage groove 5. Clip 4 may be fabricated of various known materials (e.g. plastic, metal, and so on).

After the contents of bag 2 have been exhausted, the bag-in-box system 100 may be removed from the dispensing machinery, clip 4 may be removed from groove 5, box 1 opened, bag 2 removed from box 1, and both box 1 and bag 2 may be collapsed to a relatively small volume to be discarded or recycled.

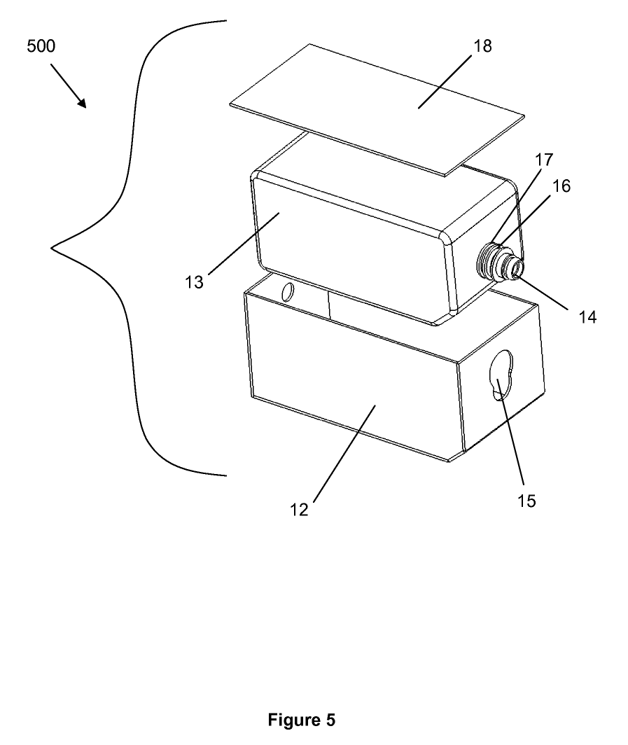

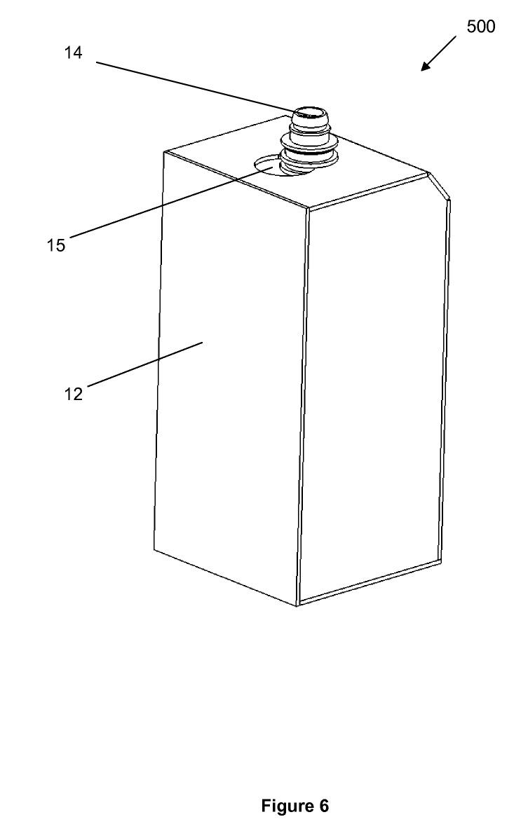

FIG. 5 illustrates an exploded view and FIG. 6 illustrates a perspective view of an embodiment of a bag-in-box container system 500. The example container system 500 includes a box 12. Box 12 may be constructed of various different materials (cardboard, plastic, and so on) to give box 12 suitable rigidity, weight, etc. for the specific application. Example container system 500 also includes a bag 13, which may contain liquids such as those used for sunless tanning, as well as other liquids for various other uses. Bag 13 may have a valved fitting or dispensing end 14 that may provide a fluidic path for fluid in bag 13. Dispensing end 14 may also have annular ringed flanges or ribs for, among other functions, connecting system 500 to equipment or machinery for dispensing the fluids inside of the bag.

Example box 12 has an opening 15 on one of its walls. Dispensing end 14 may include a flange, rib, or set of flanges or ribs forming a groove or slot 16 and opening 15 may incorporate two different diameters for dispensing end 14 to partially come through the larger diameter and engage into the smaller diameter at groove or slot 16 to resist a force pushing in a direction towards the inside of box 12. Dispensing end 14 may also include a collar 17 of a larger perimeter than the smaller diameter in opening 15 such that the collar contacts the inside of box 13 around the smaller diameter resisting bag 13 from being pulled out of box 12 through opening 15. Engagement at groove or slot 16 resists a force urging dispensing end 14 inside box 12 by, for example, force exerted on dispensing end 14 when connecting system 500 to dispensing or spraying machinery. During and after connection to the machinery, this force exerted on dispensing end 14 is distributed along the wall surface of box 12 around opening 15 contributing to the rigidity of system 500.

In one embodiment, system 500 may include a lid 18 for closing the bag-in-box container. After the contents of bag 13 have been exhausted, the bag-in-box system 500 may be removed from the dispensing machinery, lid 18 removed, bag 13 removed from box 12, and bag 13 may be collapsed to a relatively small volume to be discarded or recycled. Box 12 may be “refilled” with a full bag 13, reassembled and reinstalled on the dispensing machinery.

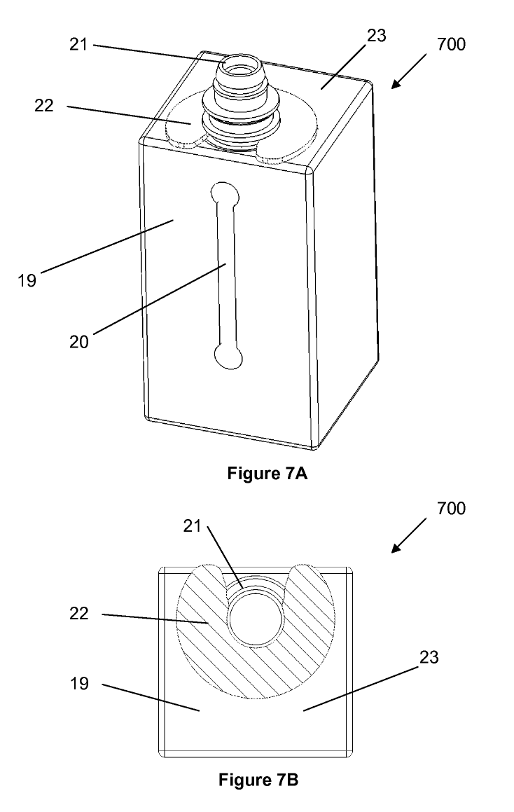

FIGS. 7A and 7B illustrates a perspective front view and a top view, respectively, of an embodiment of a bag-in-box container system 700. The example container system 700 includes a box 19. Box 19 may be constructed of various different materials (cardboard, plastic, and so on) to give box 19 suitable rigidity, weight, etc. for the specific application. Example container system 700 also includes a bag 20. Bag 20 may contain liquids such as those used for sunless tanning, as well as other liquids for various other uses. Bag 20 may have a valved fitting or dispensing end 21 that may provide a fluidic path for the fluid in bag 20. Dispensing end 21 may have annular ringed flanges or ribs for, among other functions, connecting system 700 to equipment or machinery for dispensing the fluids inside of bag 20. Example box 19 has an opening on one of its walls, in this example top wall 23, for dispensing end 21 to partially come through the opening.

To assemble bag-in-box system 700, bag 20 is inserted inside box 19 with a portion of dispensing end 21 protruding through the opening on wall 23. Dispensing end 21 may also include a collar (not shown) of a larger perimeter than the opening in box 19 such that the collar contacts the inside of wall 23 around the opening. The contact between the collar and the inside of wall 23 resists bag 20 from being pulled out of box 19 through the opening. Dispensing end 21 may also include a flange, rib, or set of flanges or ribs forming a groove or slot for a clip 22, a spring clip (not shown), or some other means of engagement to engage dispensing end 21 and resist a force pushing in a direction towards the inside of box 19.

In the example embodiment, clip 22 engages dispensing end 21 at a groove in dispensing end 21 and holds bag 20 in place relative to box 19. Engagement of dispensing end 21 and clip 22 causes clip 22 to resist a force urging dispensing end 21 inside box 19 by, for example, force exerted on dispensing end 21 when connecting system 700 to dispensing or spraying machinery. During and after connection to the machinery, clip 22 distributes, at least partially, the force exerted on dispensing end 21 along the opening end outside wall of box 19, in this case top wall 23, contributing to the rigidity of system 700.

Clip 22 may have an opening for sliding in place into the groove in dispensing end 21. The groove may be formed by two spaced walls or flanges radially extending from dispensing end 21. The groove may be located in dispensing end 21 so that the proximal most wall or flange of the groove is flush with the outside surface of the opening wall of box 19. In this example embodiment, the groove is disposed immediately outside of box 19 near the opening on wall 23. Clip 22 may then engage dispensing end 21 at the groove with at least some surface area of clip 22 remaining in contact with the outside surface of wall 23, providing for very little, if any, play of dispensing end 21 in and out of box 19.

Bag 20 may be manufactured of a flexible material. Box 19 may be designed and manufactured such that when fully assembled, bag-in-box system 700 with clip 22 engaged mimics a single, stable, rigid container.

In the example embodiment, after bag 20 has been inserted inside box 19 with dispensing end 21 protruding through the opening on wall 23, clip 22 may be inserted or slid into the groove in dispensing end 21. Clip 22 has a shape complimentary to the groove such that clip 22 tightly fits on to the groove when pressed into engagement position. In the example embodiment, when clip 22 is fully inserted into the groove, it prevents dispensing end 21 from recessing into box 19 through the opening. A bottom surface of clip 22, in turn, distributes at least some of the force applied to dispensing end 21 in the direction to the inside of box 19 across the top wall 23. This distribution of force along the larger area of top wall 23 contributes in making bag-in-box system 700 relatively rigid. The rigidity of system 700 makes it suitable for connecting to dispensing equipment even when system 700 is inverted upside-down and connected to dispensing equipment in a blind connection where substantial force may be exerted on system 700 to permit dispensing end 21 to connect to a mating fitting fixed to dispensing machinery. System 700 may be sufficiently rigid to be self supporting in such an application when mounted by means of dispensing end 21 in an inverted angled or upside-down orientation.

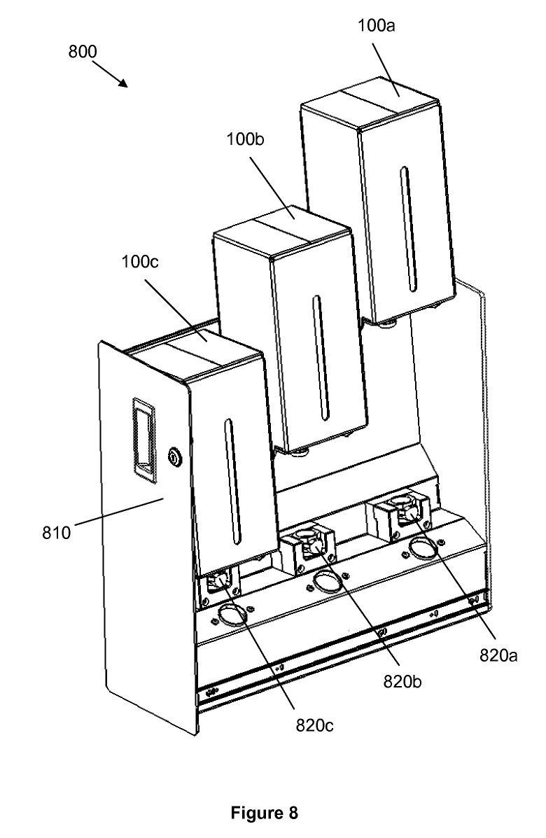

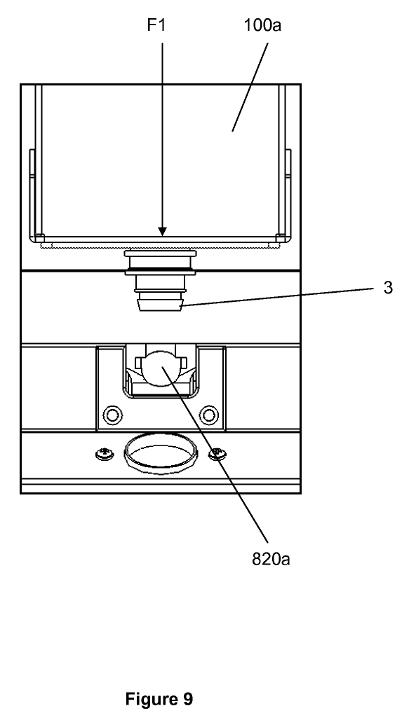

FIG. 8 illustrates a partially assembled example application 800 for bag-in-box container systems interacting with portions of a dispensing machinery 810. FIG. 9 illustrates an expanded or close-up view of the partially assembled example application 800 of FIG. 8. In example application 800, multiple bag-in-box liquid systems 100a, 100b, and 100c may be inserted into fixed holders 820a, 820b, and 820c that may be part of dispensing machinery 810. Bag-in-box system 100a, for example, is inverted for connection to holder 820a. When system 100a is inverted a force F1 including the weight of the liquid inside system 100a, is exerted on the collar that forms part of the dispensing end against the inside surface of the opening end wall of the box. The weight tends to push the dispensing end in a direction outside of the box through the opening. The collar resists the dispensing end from being pushed out the box by force F1.

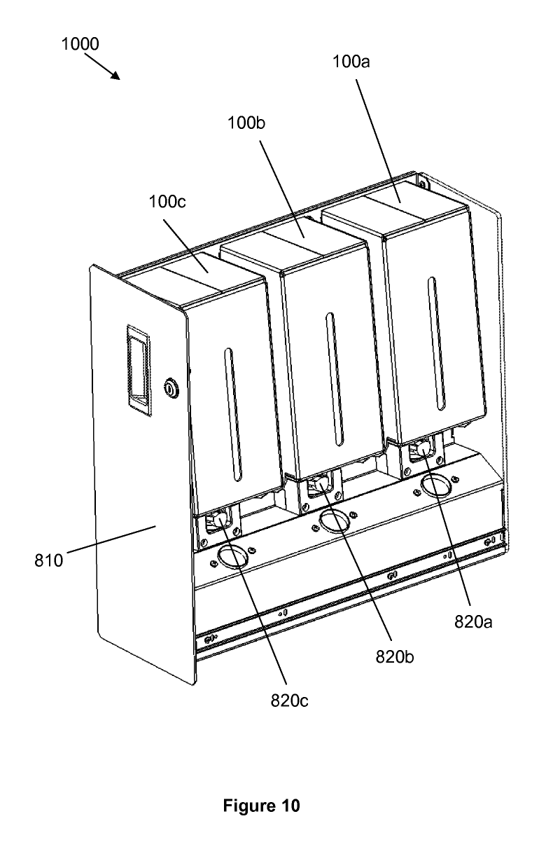

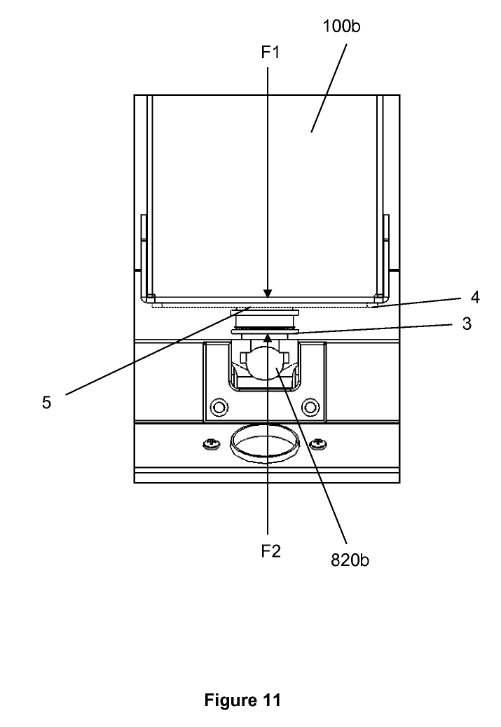

FIG. 10 illustrates a completely assembled example application 1000 for bag-in-box container systems interacting with portions of dispensing machinery 810. FIG. 11 illustrates an expanded or close-up view of the completely assembled example application 1000 of FIG. 10. In example application 1000, multiple bag-in-box systems 100a, 100b, and 100c have been inserted into fixed holders 820a, 820b, and 820c, respectively, that may be part of dispensing machinery 810. Bag-in-box system 100b, for example, is inverted for connection to holder 820b. Once system 100b is inverted and connected to holder 820b, a force F2 representing the entire weight of system 100b, including the weight of the liquid inside system 100b, is exerted on the dispensing end pushing the dispensing end in the direction of the inside of system 100b. However, one of the walls that form the groove in the dispensing end transfers the weight to the clip engaging the dispensing end or other means of engagement, and effectively distributes at least some of the weight of system 100b along the opening surface of the box. The distribution of weight makes system 100b more rigid, stable, and reliable than a comparable system without the weight distribution attributes of the clip or other means of engagement. Moreover, in the example embodiment, system 100b is sufficiently strong to withstand force F2 even when force F2 includes force applied to the dispensing end in excess of the weight of system 100b to achieve the blind connection of system 100b to holder 820b.

After the contents of the bag have been exhausted, the bag-in-box system 100b may be removed from machinery 810, the clip (if one is used in the application) may be removed from the groove, the box opened, the bag removed from the box, and the bag or both the box and the bag may be collapsed to a relatively small volume to be discarded or recycled.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” is employed. Thus, use of the term “or” herein is the inclusive, and not the exclusive use. See, Bryan A. Gamer, A Dictionary of Modem Legal Usage 624 (2d. Ed. 1995). Also, to the extent that the terms “in” or “into” are used in the specification or the claims, it is intended to additionally mean “on” or “onto.”

While the present application illustrates various embodiments, and while these embodiments have been described in some detail, it is not the intention of the applicant to restrict or in any way limit the scope of the claimed invention to such detail. Departures may be made from such details without departing from the spirit or scope of the applicant's claimed invention. Therefore, the invention, in its broader aspects, is not limited to the specific details, the representative apparatus, and illustrative examples shown and described.

1. A bag-in-box container system comprising:
a bag comprising a dispensing end, the dispensing end comprising a collar and a groove;
a box comprising a wall with an opening for a portion of the dispensing end to protrude through the opening when the bag is inside the box, the opening having a perimeter smaller than the perimeter of the collar for a surface of the collar to contact an inside-of-the-box surface of the wall for resisting a first force pulling the dispensing end in a direction towards the outside of the box through the opening; and
engaging means configured to engage the dispensing end at the groove for resisting a second force pushing the dispensing end in a direction towards the inside of the box through the opening.

2. The bag-in-box container system of claim 1, where a surface of the engaging means distributes at least some of the second force along an external wall of the box.

3. The bag-in-box container system of claim 1, where the engaging means comprise a clip that engages the groove.

4. The bag-in-box container system of claim 3, the clip comprising:
one or more engaging surfaces for the clip to engage the groove in the dispensing end protruding through the opening in the wall of the box;
one or more contacting surfaces adjacent to the one or more engaging surfaces for the contacting surfaces to contact at least one wall of the groove; and
one or more force distributing surfaces adjacent to the one or more engaging surfaces for the force distributing surfaces to distribute, at least in part, the second force along the outside of the wall of the box.

5. The bag-in-box container system of claim 4, where the one or more engaging surfaces have a total engaging perimeter in excess of half the perimeter of the groove for the clip to snap engage the groove.

6. The bag-in-box container system of claim 4, where the one or more engaging surfaces have a total engaging circumference in excess of half the circumference of the groove for the clip to snap engage the groove.

7. The bag-in-box container system of claim 4, where the one or more engaging surfaces comprise dimples for the clip to snap engage the groove.

8. The bag-in-box container system of claim 1, where the engaging means comprise a flap that is part of the box, where the flap engages the groove.

9. The bag-in-box container system of claim 1, where the engaging means include the opening having two perimeters, the opening having:
the perimeter smaller than the perimeter of the collar; and
a perimeter larger than the largest perimeter of the portion of the dispensing end for the portion of the dispensing end to come through the perimeter larger than the largest perimeter of the portion of the dispensing end and engage the perimeter smaller than the perimeter of the collar during assembly of the bag-in-box container system.

10. The bag-in-box container system of claim 1, where the engaging means include the portion of the dispensing end snap-engaging the opening.

11. A bag-in-box system comprising:
a bag;
a box; and
a clip, where the clip comprises:
one or more engaging surfaces for the clip to engage a groove in an end of the bag protruding through an opening in a wall of the box;
one or more contacting surfaces for the contacting surfaces to contact at least one groove wall for resisting a force pushing the bag into the box; and
one or more support surfaces for distributing the force pushing the bag into the box along the outside of the wall of the box.

12. The bag-in-box system of claim 11, where the one or more engaging surfaces have a total engaging perimeter in excess of half the perimeter of the groove for the clip to snap engage the groove.

13. The bag-in-box system of claim 11, where the one or more engaging surfaces have a total engaging circumference in excess of half the circumference of a circle of the same radius as the engaging surfaces for the clip to snap engage the groove.

14. The bag-in-box system of claim 11, where the one or more engaging surfaces comprise dimples for the clip to snap onto the groove when pushed into the groove.

15. A method of assembling a bag-in-box container, the method comprising:
inserting a bag in a box;
closing the box with a portion of a dispensing end of the bag protruding through an opening in the box; and
securing the portion of the dispensing end outside of the box.

16. The method of claim 15, where the securing comprises inserting a clip into a groove on the portion of the dispensing end of the bag protruding through the opening in the box.

17. The method of claim 15, where the securing comprises inserting at least a portion of a flap that is part of the box into a groove on the portion of the dispensing end of the bag protruding through the opening in the box.

18. The method of claim 15, where securing comprises:
inserting the portion of the dispensing end through a first diameter in the opening, where the first diameter is larger than a largest diameter in the portion of the dispensing end; and
engaging the dispensing end and a second diameter in the opening.

19. The method of claim 18, where engaging includes pushing the dispensing end into the second diameter.

20. The method of claim 19, where engaging includes the dispensing end snapping into the second diameter.
